(19) United States
(12) Patent Application Publication
(10) Pub. No.: US 2002/0123536 A1
(43) Pub. Date: Sep. 5, 2002

(54) Soft polyurethane foam

(76) Inventors: Hideya Kinoshita, Kanagawa (JP); Yoshihiro Katsumata, Kanagawa (JP)

Correspondence Address: STAAS & HALSEY LLP, 700 11TH STREET, NW, SUITE 500, WASHINGTON, DC, 20001, US

(21) Appl. No.: 10/042,216

(22) Filed: Jan. 11, 2002

Related U.S. Application Data
(63) Continuation-in-part of application No. 09/267,673, filed on Mar. 15, 1999, now abandoned.

(30) Foreign Application Priority Data
Mar. 18, 1998 (JP) H10-68370

(51) Int. Cl. C08K 3/00; C08J 9/00

(52) U.S. Cl. 521/88

(57) ABSTRACT

A soft polyurethane foam obtained by foaming a polyurethane raw material including a phenolic antioxidant selected from 3,9-bis[2-{3-(3-t-butyl-4-hydroxy-5-methylphenyl) propioniloxy}-1,1-dimethylethyl]-2,4,8,10-tetraoxapyro [5,5] undecane and/or 2,2′-thio-diethylene bis [3-(3,5-di-t-butyl-4-hydroxyphenyl) propionate in an amount of 0.05-2.0 parts by weight, a benzotriazole type UV absorbing agent in an amount of 0.1-3.0 parts by weight, and a phosphorus type antioxidant in an amount of 0.5-6.0 parts by weight for 100 parts by weight of a polyol component. Color migration and discoloration of a soft polyurethane foam are prevented.

### CROSS-REFERENCE TO RELATED APPLICATIONS

This application is a continuation-in-part application of, and claims the benefit under 35 U.S.C. §120 of, pending U.S. Ser. No. 09/267,673, entitled “Soft Polyurethane Foam”, filed on Mar. 15,1999.

This application also claims the benefit under 35 U.S.C. Section 119 of Japanese Patent Application Serial No. H10-68370, filed Mar. 18,1998, which is hereby incorporated by reference in its entirety into this application.

### BACKGROUND OF THE INVENTION

1. Field of the Invention

The present invention relates to a soft polyurethane foam. More particularly, the present invention relates to a soft polyurethane foam which does not cause discoloration or color migration, and which is useful for a pad material for clothing-related uses such as a brassiere pad, shoulder pad, and hanger pad, and the like.

2. Description of the Related Art

Soft polyurethane foams have good cushioning properties, and unlike cotton, they do not loose their elasticity and have a soft and good feel even after being used for a long time or repeatedly; therefore they have been widely used for a pad material for clothing-related uses such as a brassiere pad, shoulder pad, and hanger pad, and the like.

The conventional soft polyurethane foam having been produced from a polyol raw material containing BHT (dibutyl cresol) as an antioxidant, involves problems arising from the BHT, such as discoloration of the foam itself, or color migration (the cloth in contact with the soft polyurethane foam is stained). That means, when a raw material composition containing BHT is foamed to produce polyurethane, BHT remains in the foam after the foaming step, and reacts with nitrogen oxides contained in the atmosphere to yellow the urethane foam. Since BHT is sublimable, it evaporates and adheres to cloth nearby to discolor the cloth likewise.

The soft polyurethane foam discolors by the effects of ultraviolet rays as well.

Such discoloration and color migration of the foam present a significant defect of a soft polyurethane foam for clothing-related uses.

### SUMMARY OF THE INVENTION

An object of the present invention is to solve the above-mentioned conventional problems and to provide a soft polyurethane foam wherein the discoloration thereof and the color migration therefrom are prevented.

The soft polyurethane foam according to the present invention is produced by foaming a polyurethane raw material which satisfies one or more, preferably two or more, more preferably all of the following conditions (i)-(iii), and which is substantially free from BHT. (i) the polyurethane raw material includes a phenolic antioxidant selected from 3,9-bis[2-{3-(3-t-butyl-4-hydroxy-5-methylphenyl) propioniloxy}-1,1-dimethylethyl]-2,4,8,10-tetraoxapyro [5,5] undecane and/or 2,2′-thio-diethylene bis [3-(3,5-di-t-butyl-4-hydroxyphenyl) propionate in an amount of 0.05-2.0 parts by weight for 100 parts by weight of the polyol component; (ii) the polyurethane raw material includes a benzotriazole type UV absorbing agent in an amount of 0.1-3.0 parts by weight for 100 parts by weight of the polyol component; and (iii) the polyurethane raw material includes a phosphorus type antioxidant in an amount of 0.5-6.0 parts by weight for 100 parts by weight of the polyol component.

As noted above, the color migration of the soft conventional polyurethane foam occurs from sublimation and adhesion of BHT to cloth. According to the present invention, the antioxidant used in the raw material is changed from BHT to 3,9-bis[2-{3-(3-t-butyl-4-hydroxy-5-methylphenyl) propioniloxy}-1,1-dimethylethyl]-2,4,8,10-tetraoxapyro [5,5] undecane and/or 2,2′-thio-diethylene bis [3-(3,5-di-t-butyl-4-hydroxyphenyl) propionate to prevent the color migration. That is, the foam is substantially free of BHT.

The macromolecular phenolic antioxidant is preferably 3,9-bis[2-{3-(3-t-butyl-4-hydroxy-5-methylphenyl) propioniloxy}-1,1-dimethylethyl]-2,4,8,10-tetraoxapyro [5,5] undecane.

As the yellowing of the soft polyurethane foam is largely affected by UV, according to the present invention, the UV absorbing agent is added to prevent the discoloration.

In addition, the discoloration of the soft polyurethane foam with NOₓ and the discoloration of the soft polyurethane foam during hot press are effectively prevented by the use of the phosphorus type antioxidant.

### DESCRIPTION OF THE PREFERRED EMBODIMENT

Embodiments of the present invention will be explained in detail.

Each of the weight values of BHT, 3,9-bis [2-{3-(3-t-butyl-4-hydroxy-5-methylphenyl) propioniloxy}-1,1-dimethylethyl]-2,4,8,10-tetraoxapyro [5,5] undecane and 2,2′-thio-diethylene bis [3-(3,5-di-t-butyl-4-hydroxyphenyl) propionate described herein is calculated based on the atomic weights of C-12, H-1, and O-12.]

According to the present invention, color migration due to the evaporation of the antioxidant is prevented by blending a phenolic antioxidant selected from 3,9-bis[2-{3-(3-t-butyl-4-hydroxy-5-methylphenyl)propioniloxy}-1,1-dimethylethyl]-2,4,8,10-tetraoxapyro[5,5] undecane having a molecular weight of 741 and/or 2,2′-thio-diethylene bis [3-(3,5-di-t-butyl-4-hydroxyphenyl) propionate having a molecular weight of 642.9 with a polyurethane raw material, therefore the polyurethane raw material becomes substantially free from BHT. These phenolic antioxidants can be used separately or in combination.

A commercially-available example of 3,9-bis[2-{3-(3-t-butyl-4-hydroxy-5-methylphenyl) propioniloxy}-1,1-dimethylethyl]-2,4,8,10-tetraoxapyro [5,5] undecane is “AO80” and a commercially-available example of 2,2′-thio-diethylene bis [3-(3,5-di-t-butyl-4-hydroxyphenyl) propionate is “AO75”, both of which are available from Asahi Denka Kogyo K.K.

When the phenolic antioxidant selected from 3,9-bis[2-{3-(3-t-butyl-4-hydroxy-5-methylphenyl) propioniloxy}-1,1-dimethylethyl]-2,4,8,10-tetraoxapyro [5,5] undecane and 2,2′-thio-diethylene bis [3-(3,5-di-t-butyl-4-hydroxyphenyl) propionate is contained in an amount of less than 0.05 parts by weight for 100 parts by weight of the polyol component in the polyurethane raw material, the oxidation inhibition performance is weak, and the stability of the raw material itself is lowered. When the amount exceeds 2.0 parts by weight, however, the appearance of the obtained soft polyurethane foam is inferior and the raw material cost is increased. Accordingly, the amount of the antioxidant is preferably 0.05-2.0 parts by weight for 100 parts by weight of the polyol component in the polyurethane raw material.

A benzotriazole type UV absorbing agent is mixed in the polyurethane raw material to prevent the yellowing of the foam by UV. Commercially-available examples of the benzotriazole type UV absorbing agent are “T-213” available from Ciba-Geigy Ltd., and “LA-31” available from Asahi Denka Kogyo K.K., and the like. Of course, similar UV absorbing agents can be used.

When the amount of the benzotriazole type UV absorbing agent contained is less than 0.1 parts by weight for 100 parts by weight of the polyol component in the polyurethane raw material, sufficient effects can not be derived from the addition, and when the amount exceeds 3.0 parts by weight, the appearance of the obtained soft polyurethane foam is inferior and the raw material cost is increased. Accordingly the amount of the benzotriazole type UV absorbing agent used is preferably 0.1-3.0 parts by weight for 100 parts by weight of the polyol component in the polyurethane raw material.

Conventional discoloration of the foam itself caused by NOx or by hot press can be prevented by blending a phosphorus type antioxidant with the polyurethane raw material. Commercially-available examples of the phosphorus type antioxidant are “3010” and “1178”, and the like, available from Adeka Co., Ltd.

When the amount of the phosphorus type antioxidant is less than 0.5 parts by weight for 100 parts by weight of the polyol component in the polyurethane raw material, sufficient effects cannot be derived from the addition, and when the amount exceeds 6.0 parts by weight, the appearance of the resulting soft polyurethane foam is inferior and the raw material cost is increased. Therefore, the amount of the phosphorus type antioxidant blended is preferably 0.5-6.0 parts by weight for 100 parts by weight of the polyol component in the polyurethane raw material.

It is preferable that the polyurethane raw material be substantially free from BHT and contain the phenolic antioxidant selected from 3,9-bis[2-{3-(3-t-butyl-4-hydroxy-5-methylphenyl) propioniloxy}-1,1-dimethylethyl]-2,4,8,10-tetraoxapyro [5,5] undecane and 2,2′-thio-diethylene bis [3-(3,5-di-t-butyl-4-hydroxyphenyl) propionate in an amount of 0.05-2.0 parts by weight, a benzotriazole type UV absorbing agent in an amount of 0.05-1.0 parts by weight, and the phosphorus type antioxidant in an amount of 0.5-6.0 parts by weight, for 100 parts by weight of the polyol component, in order to prevent both the color migration and the discoloration of the foam itself.

A soft polyurethane foam of the present invention can be produced from an ordinary raw material, according to a conventional process such as the following method, except that the polyurethane raw material contains the predetermined antioxidants, and the like, as described above. The NCO index of the raw material is preferably 90-120.

<Polyurethane raw material composition (parts by weight)>

Polyol component: 100 parts by weight

Isocyanate component: 10-80 parts by weight

Catalyst: 0.01-2.0 parts by weight

Foaming agent: 1.0-25.0 parts by weight

Foam stabilizer: 0.1-3.0 parts by weight

All the parts by weight of the isocyante, catalyst and foaming agent and stabilizers are relative to the 100 parts by weight of the polyol component.

As for the polyol component, there is no particular restriction, however, those having a number average molecular weight of 2500-5000, an OH value of 40-60 are preferably used. A commercially-available example is GP300 from Dow Polyurethane Co., Ltd.

As for the isocyanate component, there is no particular restriction, however, an organic polyisocyanate having two or more isocyanate groups in one molecule, including aliphatic and aromatic polyisocyanate compounds and their modified products is used. Examples of the aliphatic polyisocyanate include hexamethylene diisocyanate, isophorone diisocyanate, dicyclohexylmethane diisocyanate, methylcyclohexane diisocyanate and the like. Examples of the aromatic polyisocyanate include toluene diisocyanate, diphenylmethane diisocyanate, polymeric disphenylmethane diisocyanate and the like. As their modified products, carbodiimide modified substances and prepolymer modified substances can be used. Preferable polyisocyanates according to the present invention include aromatic polyisocyanates or aromatic polyisocyanate modified products, in particular, diphenylmethane isocyanate, toluene diisocyanate, diphenylmethane diisocyanate and the like are preferred.

The foam stabilizer may be silicone oil, or the like.

As for the foaming agent, any foaming agent which can be used for production of a polyurethane foam can be used. Examples thereof include methylene chloride, flon type compounds such as trichlorofluoromethane and dichlorodifluoromethane, as a low boiling point inactive solvent, water, acid amides and nitroalkanes and the like as a substance which generates a gas by liquefied carbon dioxide gas reaction, sodium hydrogen carbonate, ammonium carbonate and the like as a substance which generates a gas by heat decomposition. Among these, methylene chloride, water and the like are preferred as the foaming agent.

As a catalyst, any catalyst which can be used for an ordinary urethane foam production can be used. Examples thereof include tin type catalysts such as dibutyltin dilaurate, stannous octoate, and tertiary amines such as triethylamine and tetramethyl hexamethylenediamine,

The polyurethane foam of the present invention may contain a surfactant, a flame retardant, or other assistants, if necessary. As a surfactant, a silicone type surfactant can be usually employed. As a flame retardant, an organic powder such as urea and thiourea or an inorganic powder such as a metal hydroxide and antimony trioxide can be used in addition to the conventionally known flame retardant such as tris (2-chloroethyl) phosphate, tris (2,3-dibromopropyl) phosphate, and the like.

Examples of other assistants include a coloring powder such as a pigment and dye, a powder such as talc, graphite, glass short fiber, and other inorganic fillers, and an organic solvent.

### EXAMPLES AND COMPARATIVE EXAMPLES

Without further elaboration, it is believed that one skilled in the art, using the preceding description, can utilize the present invention to its fullest extent. The following embodiments are, therefore, to be construed as merely illustrative, and not limitative in any way whatsoever, of the remainder of the disclosure.

The present invention is further illustrated by the following Examples and Comparative Examples.

### Examples 1-7, Comparative Examples 1-10

Polyurethane raw materials having the compositions shown in Table 1 were foamed at 25° C. according to an ordinary process to produce soft polyurethane foams. The color migration, discoloration by UV and discoloration by NOx of the produced soft polyurethane foams were examined by the following methods and the results are shown in Table 1.

<Color Migration>

A urethane foam was wrapped in a polyester cloth and allowed to stand at 50° C. for 48 hours, then the polyester cloth was exposed to 50 ppm NOₓ for 2 hours, and allowed to stand at 50° C. for 30 days. Then Yl value (based on a white plate) of the polyester cloth was measured by “ZE2000” available from Nippon Denshoku Sha K.K. The larger the Yl value, the bigger the degree of discoloration.

<Discoloration by UV>

A polyurethane foam was irradiated with UV for 9 hours using one carbon arc and the Yl value based on the white plate was determined by “ZE2000” available from Nippon Denshoku Sha K.K.

<Discoloration by NOₓ>

A polyurethane foam was allowed to stand in an atmosphere containing NOₓ of 500 ppm for 2 hours then the Yl value based on the white plate was measured by “ZE2000” available from Nippon Denshoku Sha K.K.

| | | Examples | | | | | | |
|---|---|---|---|---|---|---|---|---|
| | | 1 | 2 | 3 | 4 | 5 | 6 | 7 |
| Polyurethane | Polyol *1 | 100 | 100 | 100 | 100 | 100 | 100 | |
| foam raw | Antioxidant *2 | 0.30 | 0.30 | 0.30 | 0.30 | 0.30 | 0.30 | |
| material | Antioxidant *11 | | | | | | | 0.30 |
| compositions | Antioxidant *3 | | | | | | | |
| (wt part) | Antioxidant *4 | 5.0 | 2.0 | 5.0 | 2.0 | | | |
| | Ethanox 330 | | | | | | | |
| | Cyanox 2246 | | | | | | | |
| | Irganox 1010 | | | | | | | |
| | Irganox 1076 | | | | | | | |
| | UV absorbing agent *5 | 2.0 | 1.0 | | | 2.0 | 1.0 | 1.0 |
| | Water | 3.6 | 3.6 | 3.6 | 3.6 | 3.6 | 3.6 | 3.6 |
| | Amine catalyst *6 | 0.25 | 0.25 | 0.25 | 0.25 | 0.25 | 0.25 | 0.25 |
| | Amine catalyst *7 | 0.25 | 0.25 | 0.25 | 0.25 | 0.25 | 0.25 | 0.25 |
| | Foam stabilizer *8 | 1.2 | 1.2 | 1.2 | 1.2 | 1.2 | 1.2 | 1.2 |
| | Tin catalyst *9 | 0.5 | 0.5 | 0.5 | 0.5 | 0.5 | 0.5 | 0.5 |
| | Isocyanate *10 | 60 | 60 | 60 | 60 | 60 | 60 | 60 |
| YI value | Color migration | 0.13 | 0.22 | 0.5 | 0.48 | 0.42 | 0.55 | 0.40 |
| | UV discoloration | 10.22 | 15.13 | 26.9 | 19.51 | 19.52 | 18.43 | 21.33 |
| | NOx discoloration | 13.09 | 15.11 | 19.03 | 20.55 | 33.31 | 30.84 | 37.93 |

| | | Comparative Examples | | | | | | | | | |
|---|---|---|---|---|---|---|---|---|---|---|---|
| | | 1 | 2 | 3 | 4 | 5 | 6 | 7 | 8 | 9 | 10 |
| Polyurethane | Polyol *1 | 100 | 100 | 100 | 100 | 100 | 100 | 100 | 100 | 100 | 100 |
| foam raw | Antioxidant *2 | | | | | | | | | | |
| material | Antioxidant *11 | | | | | | | | | | |
| compositions | Antioxidant *3 | 0.30 | 0.30 | 0.30 | 0.30 | 0.30 | 0.30 | | | | |
| (wt part) | Antioxidant *4 | | 5.0 | 5.0 | | 0.30 | | | | | |
| | Ethanox 330 | | | | | | | 0.30 | | | |
| | Cyanox 2246 | | | | | | | | 0.30 | | |
| | Irganox 1010 | | | | | | | | | 0.30 | |
| | Irganox 1076 | | | | | | | | | | 0.30 |
| | UV absorbing agent *5 | 2.0 | | 2.0 | | | 0.05 | 1.0 | 1.0 | 1.0 | 1.0 |
| | Water | 3.6 | 3.6 | 3.6 | 3.6 | 3.6 | 3.6 | 3.6 | 3.6 | 3.6 | 3.6 |
| | Amine catalyst *6 | 0.25 | 0.25 | 0.25 | 0.25 | 0.25 | 0.25 | 0.25 | 0.25 | 0.25 | 0.25 |
| | Amine catalyst *7 | 0.25 | 0.25 | 0.25 | 0.25 | 0.25 | 0.25 | 0.25 | 0.25 | 0.25 | 0.25 |
| | Foam stabilizer *8 | 1.2 | 1.2 | 1.2 | 1.2 | 1.2 | 1.2 | 1.2 | 1.2 | 1.2 | 1.2 |
| | Tin catalyst *9 | 0.5 | 0.5 | 0.5 | 0.5 | 0.5 | 0.5 | 0.5 | 0.5 | 0.5 | 0.5 |
| | Isocyanate *10 | 60 | 60 | 60 | 60 | 60 | 60 | 60 | 60 | 60 | 60 |
| YI value | Color migration | 35.21 | 33.36 | 29.31 | 31.06 | 30.55 | 32.07 | 0.45 | 0.49 | 0.48 | 0.52 |
| | UV discoloration | 21.5 | 30.26 | 12.76 | 56.87 | 54.57 | 54.17 | 31.42 | 30.55 | 25.88 | 30.85 |
| | NOx discoloration | 32.47 | 20.22 | 14.05 | 60.23 | 58.94 | 57.12 | 48.23 | 45.11 | 39.99 | 50.23 |

*1 GP 3000 available from Dow Polyurethane Co., Ltd (no antioxidant is added)
*2 Phenolic antioxidant, 3,9-bis[2-{3-(3-t-butyl-4-hydroxy-5-methylphenyl) propioniloxy}-1,1-dimethylethyl]-2,4,8,10-tetraoxapyro [5,5] undecane AO80, available from Asahi Denka Kogyo K.K. (molecular weight of 741)
*11 Phenolic antioxidant, 2,2′-thio-diethylene bis [3-(3,5-di-t-butyl-4-hydroxyphenyl) propionate AO75, available from Asahi Denka Kogyo K.K. (molecular weight of 642.9)
*3 Phenolic antioxidant, BHT, available from Asahi Denka Kogyo K.K. (molecular weight of 220)
*4 Phosphorus type antioxidant, Adeka 3010, available from Asahi Denka Kogyo K.K. (molecular weight of 503)
*5 Benzotriazole type UV absorbing agent, T-213, available from Ciba-Geigy Ltd.
*6 Triethylene diamine, DABCO-33LV, available from Sankyo Airproducts Co., Ltd.
*7 A133, available from Sankyo Airproducts Co., Ltd.
*8 L6202B, silicone oil available from Nippon Unicar Co., Ltd.
*9 U-28, available from Nittoh Chemical Industries Ltd.
*10 tolylene diisocyanate, T-80, available from Dow Polyurethane Co., Ltd

Table 1 shows that the discoloration of the foam itself or the color migration can be prevented according to the present invention.

The preceding examples can be repeated with similar success by substituting the generically or specifically described reactants and/or operating conditions of this invention for those used in the preceding examples.

As described above, according to the present invention there is provided a soft polyurethane foam which is free from problems of discoloration of the foam itself or color migration, and which is useful for a pad material for clothing-related uses.

The foregoing is considered illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to that fall within the scope of the invention and the appended claims.

What is claimed is:

1. A polyurethane foam obtained by foaming a polyurethane raw material comprising:
a polyol component;
a phenolic antioxidant selected from 3,9-bis[2-{3-(3-t-butyl-4-hydroxy-5-methylphenyl) propioniloxy}-1,1-dimethylethyl]-2,4,8,10-tetraoxapyro [5,5] undecane and 2,2′-thio-diethylene bis [3-(3,5-di-t-butyl-4-hydroxyphenyl) propionate in an amount of 0.05-2.0 parts by weight for 100 parts by weight of the polyol component;
a benzotriazole UV absorbing agent in an amount of 0.1-3.0 parts by weight for 100 parts by weight of the polyol component; and
a phosphorous antioxidant in an amount of 0.5-6.0 parts by weight for 100 parts by weight of the polyol component,
wherein the polyurethane raw material is substantially free of dibutyl cresol.

2. The polyurethane foam according to claim 1, wherein the polyurethane raw material further comprises, in relation to 100 parts by weight of the polyol component, an isocyanate component (10-80 parts by weight), a catalyst (0.01-2.0 parts by weight), a foaming agent (1.0-25.0 parts by weight), and a foam stabilizer (0.01-3.0 parts by weight).

3. The polyurethane foam according to claim 2, wherein the polyol component has a number average molecular weight of 2500-5000, and an OH value of 40-60.

4. The polyurethane foam according to claim 2, wherein the isocyanate component comprises an organic polyisocyanate containing two or more isocyanate groups in one molecule and being selected from aliphatic polyisocyanate compounds, aromatic polyisocyanate compounds or modified products thereof.

5. The polyurethane foam according to claim 1, wherein the phenolic antioxidant is selected to be only 3,9-bis[2-{3-(3-t-butyl-4-hydroxy-5-methylphenyl) propioniloxy}-1,1-dimethylethyl]-2,4,8,10-tetraoxapyro {5,5} undecane.

6. The polyurethane foam according to claim 1, wherein the benzotriazole UV absorbing agent is in the amount of 0.1-2.0 parts by weight for 100 parts by weight of the polyol component.
